(19) United States
(12) Patent Application Publication
(10) Pub. No.: US 2002/0133327 A1
(43) Pub. Date: Sep. 19, 2002

(54) Acoustic response simulation system

(76) Inventor: David Stanley McGrath, Bondi (AU)

Correspondence Address: FULWIDER PATTON LEE & UTECHT, LLP, 200 OCEANGATE, SUITE 1550, LONG BEACH, CA, 90802, US

(21) Appl. No.: 10/047,279

(22) Filed: Jan. 14, 2002

Related U.S. Application Data
(63) Continuation-in-part of application No. 09/281,771, filed on Mar. 30, 1999, now abandoned.

(30) Foreign Application Priority Data
Mar. 31, 1998 (AU) PP2712
Mar. 31, 1998 (AU) PP2716
Mar. 31, 1998 (AU) PP2730

(51) Int. Cl. G06F 9/44

(52) U.S. Cl. 703/21

(57) ABSTRACT

A computer system including a series of convolution libraries, a user interface, a convolver, and a filter.

### CROSS REFERENCE TO OTHER RELATED APPLICATIONS

This application is a Continuation-in-Part of co-pending application U.S. patent application Ser. No. 09/281,771 filed Mar. 13, 1999.

### BACKGROUND OF THE INVENTION

1. Field of the Invention

The present invention relates to the utilization of sound effects and convolution in a complex creation environment.

2. Description of the Prior Art

Recently, computer systems with significant computational power have been utilized in the area of sound mixing and creation.

However, a number of significant factors affect the quality of sound reproduction, including spatialization, over a standard PC type system. These can include the output speakers used, the output environment, the desired simulated environment, the desired localization and binaural response and any musical effects that may be desired. Unfortunately, the number of variations of the effects and/or variables that affect a particular sound's reproduction has also proliferated.

To capture and reproduce the sound emanating from a particular audio environment, some systems have relied on convolving recorded impulse responses with audio signals, however, such systems are under-utilized due to their complexity of operation.

### SUMMARY OF THE INVENTION

The present invention is directed to a computer system that provides an improved and more versatile form of distribution of sound altering convolution components. The system includes a convolver that convolves selected functions chosen from a series of convolution libraries via a user interface into a convolution. The user interface is a graphical user interface having a browse function that may be adapted to display selections from the convolution functions of the libraries. A filter combines the convolution with an audio stream for audio output by the computer system, and the system can also include storage means for storing the combined convolution for subsequent retrieval and processing by the filter.

The convolution libraries are directed to many environments, and, by way of example, may include a Speaker Equalization Library, a Room Model Library, a Binaural Response Library and a Musical Effects Library. These libraries may be located over a wide area network, and may be conveniently organized into folders having files for the individual convolution functions to be found therein.

Advantageously, the convolver includes n−1 convolving means for convolving together n selected convolution functions. The convolving means may operate on the basis of the following algorithms, wherein s(k), r(k), b(k) and m(k) are selected response functions, and NS, NR, NB and NM are the corresponding number of samples in each function:

$$\begin{matrix}{c}^{″} ( k ) = {\sum }_{i = o}^{NS - 1} s ( i ) \times r ( k - i ) & \{ k = 0 … NS + NR - 2 \} \\ {c}^{′} ( k ) = {\sum }_{i = 0}^{NB - 1} b ( i ) \times {c}^{″} ( k - i ) & \{ k = 0 … NS + NR + NB - 3 \} \\ c ( k ) = {\sum }_{i = 0}^{NM - 1} m ( i ) \times {c}^{′} ( k - i ) & \{ k = 0 … NS + NR + NB + NM - 4 \}\end{matrix}$$

### BRIEF DESCRIPTION OF THE DRAWINGS

Notwithstanding any other forms which may fall within the scope of the present invention, preferred forms of the invention will now be described, by way of example only, with reference to the accompanying drawings in which:

FIG. 1 illustrates schematically a first embodiment of the invention;

FIG. 2 illustrates a flowchart of the operation of the first embodiment in more detail;

FIG. 3 illustrates a functional block diagram of the first embodiment;

FIG. 4 illustrates a one version of graphical user interface forming part of the invention;

FIG. 5 shows an arrangement of the libraries implemented as a file system, and

FIG. 6 shows a more detailed functional block diagram of the convolver and the filter forming part of the computer system of the invention.

### DETAILED DESCRIPTION OF THE EMBODIMENTS

In one preferred embodiment, there is provided a system which allows for a wide range of impulse response functions to be utilized, in a user selectable manner, so as to provide for a wide range of effects.

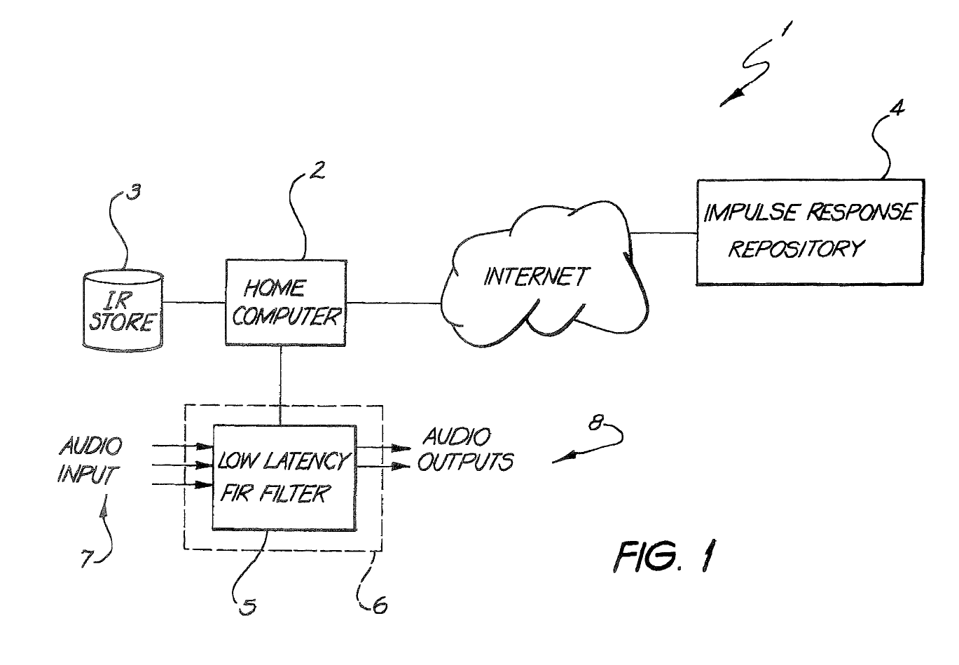

Turning now to FIG. 1 there is provided a schematic view of a first embodiment 1 which includes a computer system 2 interconnected to a number of impulse response function libraries 3, 4. The libraries can preferably be accessible over the Internet and on local storage 5 by means of adaption of a standard Internet browser using standard Internet protocols.

A user selectable impulse response is selected by a user and downloaded into an on-board DSP 6 (such as those located within a sound card) within the home computer 2. The sound card is programmed to provide convolution of the selected impulse response with a series of audio inputs 7 so as to provide audio outputs 8. The DSP board 6 preferably is fully programmable in a manner described further on in the specification so as to provide for the convolution of a large number of audio inputs with impulse response functions to produce a predetermined number of outputs.

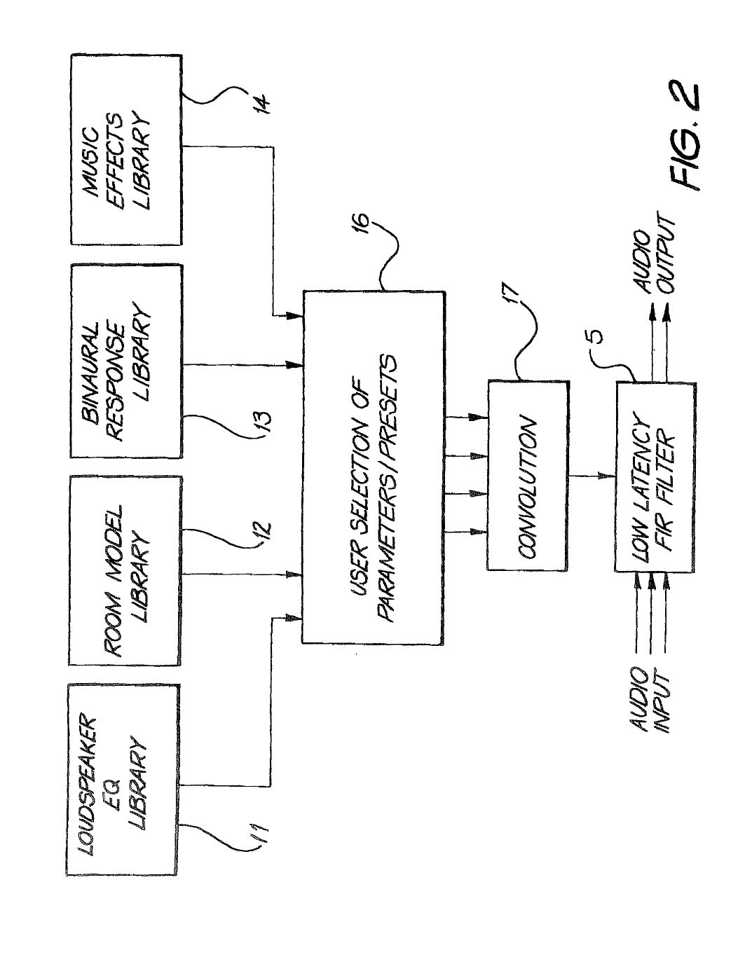

In a refinement, a large selection of different impulse responses can be provided and divided into a number of libraries as illustrated in FIG. 2. In this refinement, a series of different convolution functions are provided in separate libraries 11-14. These libraries can provide firstly for a plethora of different effects and secondly for a plethora of different variations of each effect. Again the libraries can be located over an Internet type network. The effects can provide for different loudspeaker equalizations 11, different room effects 12, different binaural responses 13 and different musical effects 14. The user interface 16 is provided for selecting a particular collection of effects from the library.

Once a series of effects have been selected by a user, the corresponding impulse response for each effect is convolved together at 17 before being output in the form of coefficients to a Low Latency FIR filter 5 that is able to run in real time on the computer system. A suitable low latency filter system is disclosed, for example, in U.S. Pat. No. 5,502,747.

Through the provision of the arrangement of FIG. 2, a high level of flexibility is provided in the provision of an improved sound response over a standard computer system equipped with a sound card.

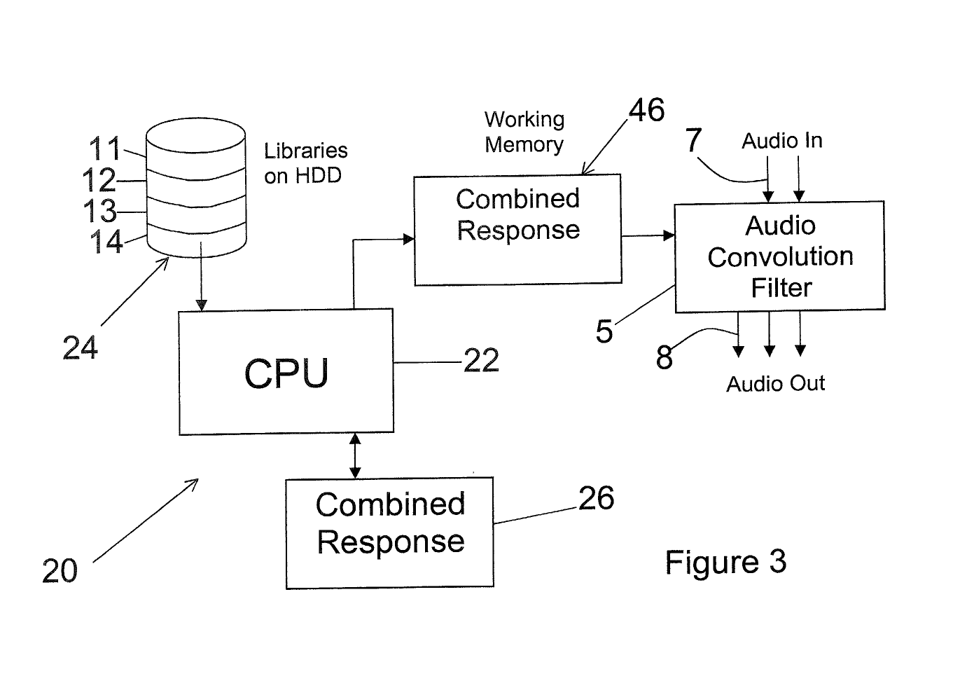

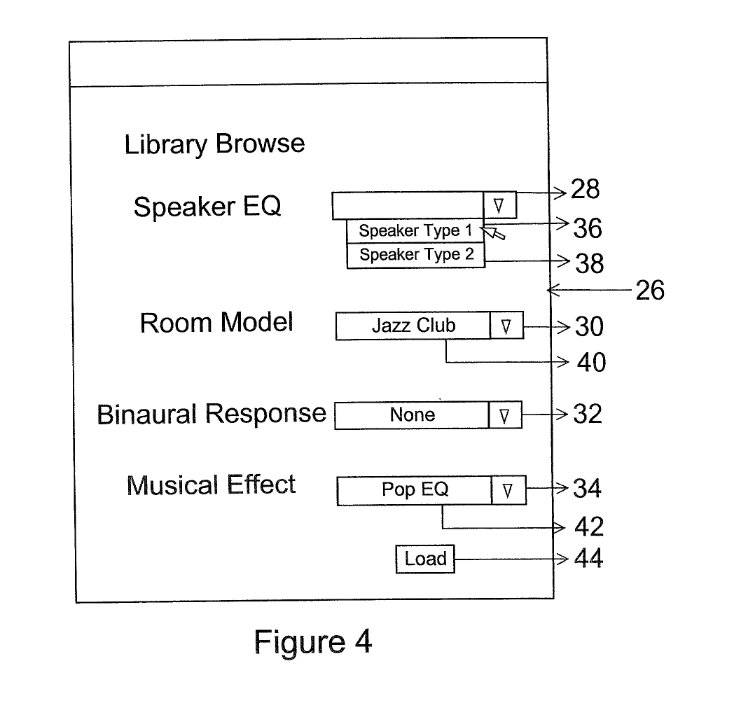

Referring now to FIG. 3, a more detailed functional block diagram of a computer system 20 of the invention is shown comprising a CPU 22, a hard disk drive 24 containing the libraries 11, 12, 13 and 14 and a graphical user interface 26. The libraries may previously have been downloaded into the hard disk drive via the internet. The CPU 22 may alternatively be in the form of the sound card-based DSP 6. The graphical user interface 26 is illustrated in more detail in FIG. 4. Each of the loudspeaker, room model, binaural response and musical effect libraries are provided with drop-down menu functions 28, 30, 32 and 34 respectively through which the user can browse. For example, the loudspeaker equalization library may provide equalization options for different types of speakers, only two of which are shown at 36 and 38. In the particular example, the “jazz club” function 40 has been selected from the room model library. No binaural response has been selected, and the “pop EQ” function 42 has been selected from the musical effect library. Once the various selections have been made, the “load” button 44 is activated, thereby initiating the convolution process whereby the selected impulse response functions are convolved with one another in the CPU 22 to yield a combined response function which is loaded into a working memory 46. Thereafter, the combined response function is convolved in real time with the input audio stream 7 using the low latency FIR filter 5, which acts as an audio convolution filter to yield a convolved audio output stream displaying the effects selected by the user.

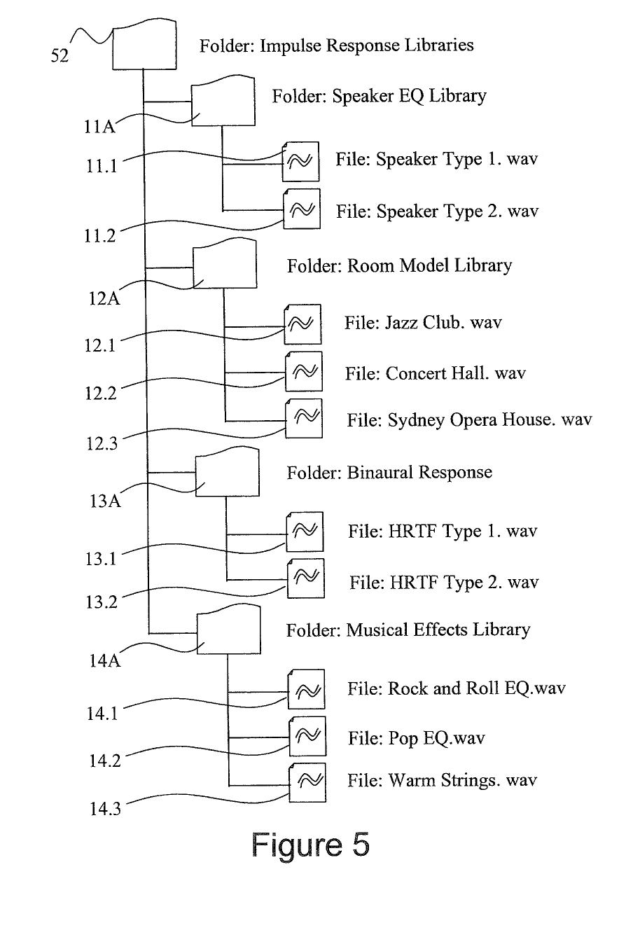

Referring now to FIG. 5, the libraries 11, 12, 13 and 14 are shown implemented as a file system. Each of the libraries is contained with separate respective folders 11A, 12A, 13A and 14A within which individual files are contained. By way of example, the speaker equalization library includes speaker type 1.wav and speaker type 2.wav files 11.1 and 11.2 respectively. Similarly, the room model library 12 contains respective “jazz club”, “concert hall” and “Sydney Opera House” files 12.1, 12.2 and 12.3. The binaural response library contains HRTF type 1 and HRTF type 2 files 13.1 and 13.2, and the musical effects library 14 contains “rock'n roll”, “pop equalization” and “warm strings” files 14.1, 14.2 and 14.3 respectively. The folders 11A, 12A, 13A and 14A are in turn contained within an impulse response library 52. The library arrangement may also serve as a graphical user interface in which files can be selected, dragged and dropped into the main impulse response folder 52 to be subsequently convolved together by the CPU 22.

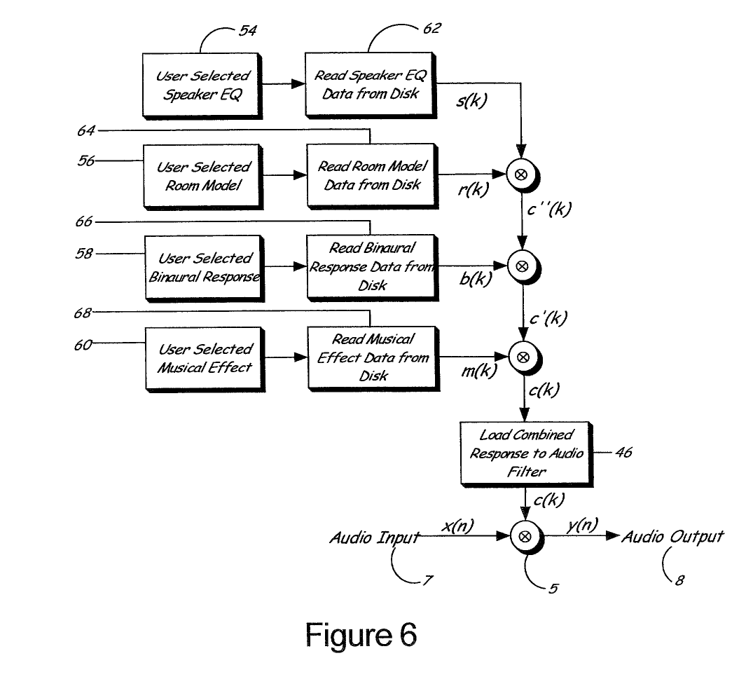

FIG. 6 illustrates in more detail the manner in which the initial series of convolutions 17 and the subsequent convolution by the audio filter 5 is carried out in a situation where all four libraries are utilized. In response to the respective user selections 54, 56, 58 and 60, the CPU 22 reads from the hard disk containing the libraries 11, 12, 13 and 14 the speaker equalization data 62, the room model data 64, the binaural response data 66 and the musical effect data 68 to yield respective response functions s(k), r(k), b(k) and m(k). The combined response function c(k) is derived by convolving s(k) with r(k) to yield c″(k). C″(k) is then convolved with b(k) to yield c′(k), and m(k) is convolved with c′(k) to yield the combined response c(k). This process is carried out according to the following algorithms:

$${c}^{″} ( k ) = {\sum }_{i - 0}^{NS - 1} s ( i ) \times r ( k - i ) \{ k = 0 … NS + NR - 2 \} , \qquad ( 1 )$$

Speaker Equalization response=s(k), k=0 . . . NS−1 and Room Model response=r(k), k=0 . . . NR−1

$${c}^{′} ( k ) = {\sum }_{i = 0}^{NB - 1} b ( i ) \times {c}^{″} ( k - i ) \{ k = 0 … NS + NR + NB - 3 \} , \qquad ( 2 )$$

Binaural response=b(k), k=0 . . . NB−1

$$c ( k ) = {\sum }_{i = 0}^{NM - 1} m ( i ) \times {c}^{′} ( k - i ) \{ k = 0 … NS + NR + NB + NM - 4 ) , \qquad ( 3 )$$

Musical Effect response=m(k), k=0 . . . NM−1

Thereafter, c(k) is convolved with the audio input x(n) to yield y(n) according to the following formula:

$$y ( n ) = {\sum }_{i = 0}^{N - 1} c ( i ) \times x ( n - i ) , \qquad ( 4 )$$

Combined Response=c(k), k=0 . . . N−1, where N NS+NR+NB+NM−3

The response function which is most memory intensive is the room impulse response. This typically takes up about 1M Words of memory, with each word equalling 32 bits. The balance of the responses generally take up anything from 1 to 100K Words of memory, with the result that the combined function is typically of the order of 1.1 to 1.2M Words long.

It will be appreciated by a person skilled in the art that numerous variations and/or modifications may be made to the example embodiment. For example, the libraries might include slowly variable impulse responses and various user interface controls for slowly varying an impulse response characteristics. Additionally, the user interface may be integrated into an automated system, such as a computer game, whereby the convolution functions are changes throughout the game depending on the atmosphere provided.

The preferred embodiment also allows for third party-developed convolution impulse responses to be downloaded and utilized, thereby creating the potential for advancements in convolution processing to be made via the interchange of experimental responses, particularly via a medium such as the internet.

One added benefit of this system is that it will allow performers or users to maintain their own private set of impulse responses that they consider as their own property, perhaps stored on disk etc. and which is loadable into the system on demand.

Through the provision of a flexible system for loading coefficients, a ready form of distribution system arises whereby individuals are able to record their own unique response functions and distribute them to other owners of the preferred embodiment for a fee, thereby adding value to the overall system.

It would be further appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

It will be understood that the invention disclosed and defined herein extends to all alternative combinations of two or more of the individual features mentioned or evident from the text or drawings. All of these different combinations constitute various alternative aspects of the invention.

The foregoing describes embodiments of the present invention and modifications, obvious to those skilled in the art can be made thereto, without departing from the scope of the present invention.

What is claimed is:

1. A computer system comprising:
a series of convolution libraries for the production of different sound effects;
a user interface for selection of a convolution function from each of said libraries;
a convolver for convolving said selected convolution functions together to form a combined convolution;
a filter for convolving said combined convolution with an audio stream for audio output by said computer system; and
said series of convolution libraries includes at least one library selected from a group consisting of a Speaker Equalization Library, a Room Model Library, a Binaural Response Library and a Musical Effects Library.

2. A computer system as set forth in claim 1 wherein:
said convolution libraries are located over a wide area network.

3. A computer system as set forth in claim 1, further comprising:
a detachable storage means for storing portions of said convolution libraries.

4. A computer system as set forth in claim 1 wherein:
said series of convolution libraries includes at least two libraries selected from a group consisting of a Speaker Equalization Library, a Room Model Library, a Binaural Response Library and a Musical Effects Library.

5. A computer system as set forth in claim 1, wherein:
said user interface is a graphical user interface having a browse function for enabling display and selection of each of the convolution functions in each of the libraries.

6. A computer system as set forth in claim 1, wherein:
said convolution libraries are arranged in folders, with the individual convolution functions being arranged in identifiable files in each folder.

7. A computer system as set forth in claim 1, wherein:
said convolver includes n−1 convolving means for convolving together n selected convolution functions.

8. A computer system as set forth in claim 1, wherein:
said convolver includes convolving means operating on the basis of the following algorithms, wherein s(k), r(k), b(k) and m(k) are selected response functions, and NS, NR, NB and NM are the corresponding number of samples in each function:
$$\begin{matrix}{c}^{″} ( k ) = {\sum }_{i = o}^{NS - 1} s ( i ) \times r ( k - i ) & \{ k = 0 … NS + NR - 2 \} \\ {c}^{′} ( k ) = {\sum }_{i = 0}^{NB - 1} b ( i ) \times {c}^{″} ( k - i ) & \{ k = 0 … NS + NR + NB - 3 \} \\ c ( k ) = {\sum }_{i = 0}^{NM - 1} m ( i ) \times {c}^{′} ( k - i ) & \{ k = 0 … NS + NR + NB + NM - 4 \}\end{matrix} .$$

9. A computer system comprising:
a series of convolution libraries for the production of different sound effects;
a user interface for selection of a convolution function from each of said libraries;
a convolver for convolving said selected convolution functions together to form a combined convolution;
memory for storing the combined convolution for subsequent retrieval and processing by a filter for convolving said combined convolution with an audio stream for audio output; and
said series of convolution libraries including at least one library selected from a group consisting of a Speaker Equalization Library, a Room Model Library, a Binaural Response Library and a Musical Effects Library.

10. A computer system comprising:
a series of convolution libraries for the production of different sound effects;
a user interface for selection of a convolution function from each of said libraries;
means for convolving said selected convolution functions together to form a combined convolution;
means for convolving said combined convolution with an audio stream for audio output by said computer system; and
said series of convolution libraries includes at least one library selected from a group consisting of a Speaker Equalization Library, a Room Model Library, a Binaural Response Library and a Musical Effects Library.
